(19) United States
(12) Patent Application Publication
(10) Pub. No.: US 2025/0089626 A1
(43) Pub. Date: Mar. 20, 2025

(54) SYSTEMS AND METHODS OF UTILIZING ULTRASONIC WAVES TO PROMOTE PLANT GROWTH

(71) Applicant: Maximum Technology Corporation, Huntsville, AL (US)

(72) Inventor: Jonathan RICHARD, Huntsville, AL (US)

(21) Appl. No.: 18/890,556

(22) Filed: Sep. 19, 2024

Related U.S. Application Data
(60) Provisional application No. 63/539,156, filed on Sep. 19, 2023.

(51) Int. Cl. A01G 7/04

(52) U.S. Cl. CPC A01G 7/04

(57) ABSTRACT

The present disclosure a system and method of utilizing ultrasonic waves to promote plant growth. The system and method are configured to emit ultrasonic frequencies covering a sweeping range, maximizing the ability to generate standing wave resonance with various sizes of plant leaves and stems. One or more surfaces of the plant are vibrated generating standing wave resonance and increasing turgor pressure in the surfaces of said plant. The sweeping range of frequencies is capable of generating standing wave resonances at a plurality of wavelengths while the plants grows.

### CROSS-REFERENCE TO RELATED APPLICATIONS

This application claims the benefit of and priority to U.S. Provisional Application No. 63/539,156, filed on Sep. 19, 2023, and entitled “Systems and Method of Ultrasonic Utilization to Promote Plant Growth,” the disclosure of which is expressly incorporated by reference in its entirety.

### FIELD

The present disclosure relates generally to plant growth systems and methods, and specifically a plant growth system and method utilizing ultrasonic waves.

### BACKGROUND

The growth of living organisms, including plant life, is essential to sustaining virtually all life forms. Plant life, for example, provides sustenance for humans, animals, and other living organisms. Plant life, in part, uses carbon dioxide from its environment and, through photosynthesis, produces oxygen necessary for creating an atmosphere sufficient to permit all forms of life to be created and sustained.

In its natural form, plant life serves as food for animals, humans and a wide variety of other creatures and organisms. In addition, of course, plant life can be used, processed, or otherwise modified to form a multiplicity of products. Furthermore, new varieties of plant life are continuously being created both spontaneously in nature as well as by human experimentation, plant breeding and the like. Such plant breeding and discovery result both in new forms of plant life which can be employed in a multitude of uses as well as yielding new types of commodities produced thereby. Examples abound in the form of food products such as fruits, nuts, vegetables, and the like, and new types of plant life employed for other uses such as in landscaping, construction, heating, medicine, and virtually endless other uses.

For numerous years, there has been a human interest in enhancing plant growth through the utilization of soundwaves. The historical pursuit of encouraging plant growth by exposing them to sonic vibrations can be traced back to the 1800s, when Charles Darwin initially conducted experiments involving plants and sound. It is established that plants possess the inherent ability to emit sound waves, typically at relatively low frequencies ranging from 50 to 120 Hz, spontaneously. Additionally, it is established that plants can absorb and resonate with certain external frequencies.

The fundamental concept behind stimulating plant growth through soundwaves lies in the resonance of these waves within plant cells. Resonance refers to the tendency of systems to vibrate at maximum amplitude at specific frequencies. In plant cells, sound wavs at particular frequencies can resonate with the structures inside, such as the cell walls, vacuoles, and cytoplasm. This resonance has the capacity to activate metabolic processes and facilitate the movement of cell molecules and protoplasts. The increased movement of molecules and protoplasts can enhance the rate of enzymatic reactions, boost photosynthetic efficiency, and affect nutrient absorption. These metabolic activities are critical for growth, energy productions, and the synthesis of essential compounds such as proteins and hormones, contributing to the overall health and growth of the plant. Previous technical examinations have demonstrated that music or human voices have the potential to trigger various effects on plant growth.

Sound is a manifestation of acoustic energy, taking the shape of a pulsating and forceful pressure wave that travels through solids, liquids, and gases. Within the realm of acoustics, the most basic frequency category is known as infrasound, which encompasses frequencies below approximately 20 Hz. On the other hand, ultrasound refers to acoustic waves characterized by frequencies exceeding 20 kHz. Both ultrasound and infrasound have the capacity to engage with organic tissues through a combination of thermal and mechanical mechanisms.

The intensity of sound is measured in decibels (dB), which quantifies the sound pressure level (SPL) relative to a reference value. Human hearing typically perceives sounds between 0 dB (the threshold of hearing) and 120-130 dB (the threshold of pain). Prolonged exposure to sounds at or above 85 dB SPL can result in hearing damage, as the hair cells in the inner ear may become stressed or permanently damaged. At extremely high decibel levels, such as those above 120 dB SPL, immediate damage may occur, potentially leading to irreversible hearing loss.

As it pertains to ultrasonic frequencies, while they are beyond the audible range of hearing, ultrasonic waves can still affect biological tissues, depending on the amplitude. As such, it is imperative that the decibel levels of ultrasonic waves remain below harmful thresholds to avoid potential negative health effects. In the context of utilizing ultrasonic waves to promote plant growth, challenges lie in optimizing the ultrasonic output for stimulating plant growth, while remaining below the threshold of SPL that could pose risks to human health or hearing.

At present, ultrasonic transmitters find application in various devices and systems. For instance, they are integrated into certain automobiles and robotic vacuum cleaners to gauge distances to objects. These applications typically involve the periodic transmission of brief sound pulses. It's important to note that the sound sources in these cases are neither stationary nor consistent enough to promote plant growth.

Furthermore, within existing technology, there are ultrasonic pest repellent devices that rely on ultrasonic waves. However, these devices often lack clear information regarding their output levels and continuous emission, and they are not marketed for use in proximity to plants. Additionally, the low power output and irregular emission patterns associated with such ultrasonic pest repellents are not conducive to fostering plant growth.

Numerous experiments have been conducted to investigate the impact of acoustic waves on plant growth. However, these prior experiments were constrained by at least three critical factors. Firstly, the acoustic sounds used fell within the range of human hearing, leading to significant noise pollution in the human auditory spectrum. Secondly, the sound pressure levels (SPL) in the ultrasonic range were relatively low, typically ranging from 80 to 90 decibels (dB). Thirdly, the acoustic tones changed rapidly, preventing the achievement of resonance with plant structures.

In the field of acoustics, the speed of sound, denoted as “c,” is equal to 343 meters per second (m/s). The equation to calculate the wavelength, represented as “λ,” corresponding to a frequency, denoted as “f,” is given by λ=c/f, where λ is in meters, and f is in Hertz (Hz). For example, at 40 kHz, the wavelength is approximately 0.86 cm or 0.337 inches, roughly equivalent to ⅓ inch. When a leaf or stem of a plant resonates at a frequency proportional to half of this wavelength (½ λ), it experiences strong vibrations. These vibrations aid in increasing the turgor pressure within the leaf. As shown in FIG. 1, harmonics, integral components of complex waveforms, exhibit distinct characteristics as they progress in frequency multiples of the fundamental frequency. These harmonics impact the behavior and characteristics of waveforms and systems.

At lower frequencies, such as 5 kHz, the half wavelength may target a leaf that is a multiple of 1.35 inches, but non-half wavelengths are less effective. In contrast, at a higher frequency like 40 kHz, half of the wavelength is approximately ⅙ inch. In addition to the resonance wavelength, there is a minimum resonant duration that must occur. As shown in FIG. 2, when sound is initially started, there is a transient phase while the standing wave is building. After full resonance, maintaining the same wavelength/frequency keeps the vibration to a maximum. When playing music, the acoustic frequencies change rapidly and are thus not the best option for building resonance in the leaves. Thus, to achieve optimal resonance acoustic frequencies need to be emitted consistently and for a duration for the wavelength to transition from the transient phase into a standing wave, as depicted in FIG. 5.

To illustrate, the leaves and stems of a plant can be likened to antennas. Antennas efficiently absorb energy when the signal's wavelength is around half or greater of the antenna's size. When an ultrasonic acoustic wave interacts with the leaves and stems of a plant, they vibrate in response to the standing wave created by the acoustic wave. This vibration seems to encourage leaf capillaries to facilitate the exchange of air molecules with the plant, leading to improved turgor pressure in the leaves. To optimize turgor pressure in plant structures using ultrasonic waves and stimulate plant growth, it's essential to generate a standing wave resonance.

However, as a plant grows the resonance frequencies of the plant structures also change. Thus, there exists a need in the prior art for a system and method that can utilize ultrasonic waves to stimulate plant growth across a range of frequencies, allowing the generation of standing wave resonance with various plant, leaf, and stem sizes.

### SUMMARY OF THE INVENTION

As disclosed herein, the present disclosure is a system and method of utilizing ultrasonic waves to promote plant growth. The ultrasonic plant growth system of the present disclosure comprises a power source, a controller, and one or more transducers and method having of having one or more transducers capable of emitting a range of ultrasonic waves directed at a plant surface at varying frequencies in order to optimize resonant frequencies associated with a variety of plant leaves and stems. These emitted ultrasonic frequencies cover a sweeping range, maximizing the ability to generate standing wave resonance with various sizes of plant leaves and stems.

The disclosed method consists of subjecting the surface of said plant to ultrasonic waves for a predetermined duration. The said ultrasonic waves are applied through a predetermined sweeping range of frequencies at a predetermined frequency sweep rate. The sweeping range of frequencies ensures that various resonant frequencies are covered, which are capable of producing standing wave resonance across different parts of the said plant's surface. The standing wave resonance causes the surface of the plant to vibrate leading to an increase in turgor pressure in the plant's cells.

Advantageously, the present disclosure optimizes the promotion of plant growth throughout the entire plant growth cycle. An additional advantage is that the output levels are beyond the range of human hearing, eliminating noise pollution while enhancing plant growth promotion. Furthermore, the present disclosure emits ultrasonic waves at SPLs high enough to promote plant growth but below the threshold that could cause hearing damage or loss to a user.

### BRIEF DESCRIPTION OF THE DRAWINGS

The present disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 depicts an ultrasonic plant growth system as described in accordance with some embodiments of the present disclosure.

FIG. 2. a block diagram depicting an exemplary controller in accordance with some embodiments of the present disclosure.

FIG. 3. a flowchart depicting an exemplary method for utilizing ultrasonic waves to promote plant growth in accordance with some embodiments of the present disclosure.

FIG. 4A a flowchart depicting an additional exemplary method for utilizing ultrasonic waves to promote plant growth in accordance with some embodiments of the present disclosure.

FIG. 4B a flowchart depicting an additional exemplary method for utilizing ultrasonic waves to promote plant growth in accordance with some embodiments of the present disclosure.

FIG. 5 is an illustration of an integer multiple of harmonics of a fundamental frequency in accordance with some embodiments of the present disclosure.

FIG. 6 is an illustration of exemplary standing wave resonance in accordance with some embodiments of the present disclosure.

FIG. 7 is a graph showing a growth rate of regularly grown plants versus plants exposed to ultrasonic waves in accordance with some embodiments of the present disclosure.

FIG. 8 is a graph showing the growth rate of regularly grown plants versus plants exposed to ultrasonic waves in accordance with some embodiments of the present disclosure.

### DETAILED DESCRIPTION

### A. Definitions

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Numerical quantities given in this description are approximate unless stated otherwise, meaning that the term “about” or “approximately” can be inferred when not expressly stated.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached, or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting. As used herein, the singular forms “a”, “an” and “the” are intended to include the plural forms as well, unless the context clearly indicates otherwise.

Spatially relative terms, such as “under”, “below”, “lower”, “over”, “upper” and the like, may be used herein for ease of description to describe one element or feature's relationship to another when the apparatus is right side up.

The terms “first”, “second”, and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

“Turgor pressure” as used herein, refers to the internal pressure exerted by water-filled vacuoles against cells walls of biological organisms.

Terms such as “at least one of A and B” should be understood to mean “only A, only B, or both A and B.” The same construction should be applied to longer list (e.g., “at least one of A, B, and C”).

The term “consisting essentially of” means that, in addition to the recited elements, what is claimed may also contain other elements (steps, structures, ingredients, components, etc.) that do not adversely affect the operability of what is claimed for its intended purpose as stated in this disclosure. Importantly, this term excludes such other elements that adversely affect the operability of what is claimed for its intended purpose as stated in this disclosure, even if such other elements might enhance the operability of what is claimed for some other purpose.

In some places reference is made to standard methods, such as but not limited to methods of measurement. It is to be understood that such standards are revised from time to time, and unless explicitly stated otherwise reference to such standard in this disclosure must be interpreted to refer to the most recent published standard as of the time of filing.

It is to be understood that any given element of the disclosed embodiments of the invention may be embodied in a single structure, a single step, a single substance, or the like. Similarly, a given element of the disclosed embodiment may be embodied in multiple structures, steps, substances, or the like.

### B. Systems of Ultrasonic Utilization to Promote Plant Growth

The embodiments set forth below represent the necessary information to enable those skilled in the art to practice the disclosure and illustrate the best mode of practicing the disclosure. Upon reading the following description in light of the accompanying drawings, those skilled in the art will understand the concepts of the disclosure and will recognize applications of these concepts not particularly disclosed herein. It should be understood that those concepts and applications fall within the scope of the disclosure and accompanying claims.

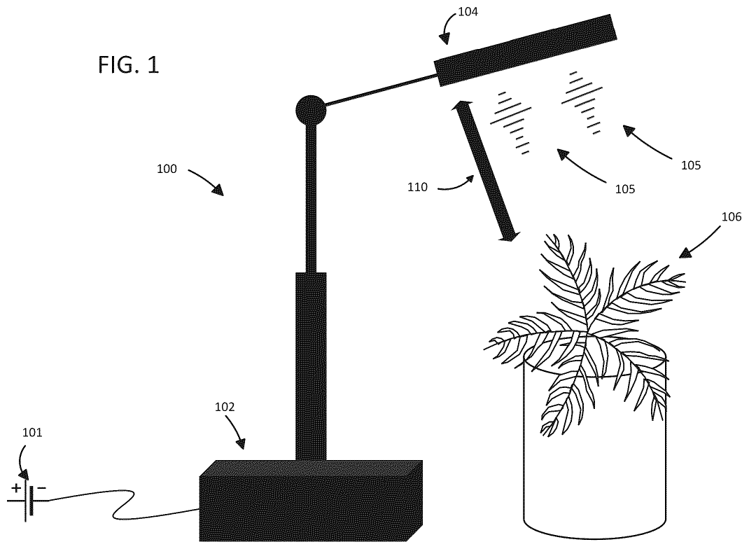

FIG. 1 depicts an ultrasonic plant growth system as described in one embodiment of the present disclosure. The present disclosure provides a system 100 for utilizing ultrasonic waves to enhance plant growth. The system 100 of the present disclosure is capable of transmitting sound waves at both high and low duty cycles, allowing for flexible control over the sound wave's active and inactive periods. Additionally, the system 100 is equipped to generate and transmit sound waves at ultrasonic frequencies exceeding 22 kHz and exceeding 80 dB SPL at a distance 110 of at least 30 cm, enabling its use in applications requiring high-frequency sound waves beyond the range of human hearing and below the threshold for hearing loss or damage.

As shown in FIG. 1, the ultrasonic plant growth system 100 of the present disclosure comprises a power source 101, a controller 102, and one or more transducers 104 and method having of one or more sound transducers capable of receiving an electrical signal and based on the electrical signal, emitting a range of ultrasonic waves 105 directed at a plant surface 106 at varying frequencies in order to cause portions of the plant to vibrate at a frequency determined to promote plant growth. In this manner, the system 100 can direct sound energy toward surfaces of the plant across a range of frequencies in order to expose the plant to at least one frequency that promotes plant growth. The system 100 thus can optimize resonant frequencies associated with a variety of plant leaves and stems.

The power source 101 is electrically coupled to the controller 102 for providing power to components of system 100. The power source 101 may include one or more power supplies such as a physical connection to AC power, DC power, or a battery. Power source 101 may include power conversion circuitry for converting an AC or DC power source into a plurality of DC voltages for use by components of system 100. When power source 101 includes a battery, the battery may be charged via a physical power connection, via inductive charging, or via any other suitable method. Although not depicted as physically connected to the other components of the system 100 in FIG. 1, power source 101 may supply a variety of voltages to the components of the system 100, such as controller 102, transducers 104, or other components in accordance with one or more operational requirements of those components.

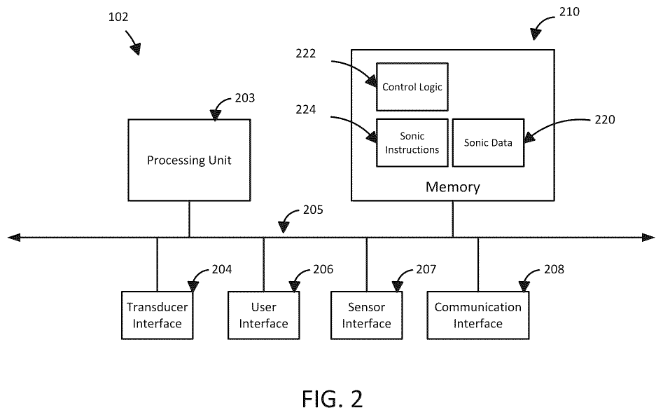

As described further with regard to FIG. 2, in some embodiments, controller 102 may be configured to control transducers 104 to generate one or more ultrasonic waves 105. A frequency of the one or more ultrasonic waves 105 may have a SPL greater than about 80 dB SPL at a distance 110 of at least 30 cm, but below a threshold SPL at which damage to human hearing can occur (a “safe hearing threshold”). The FIGs. depict processing unit 203 as being a component of controller 102 and housed in the same enclosure, but in some embodiments, controller 102 may be physically separated (e.g., in a different physical enclosure) from processing unit 203 yet may remain capable of communicating with processing unit 203. Controller 102 may be capable of executing instructions stored in memory to provide signals to one or more transducers 104 to generate ultrasonic waves across a range of frequencies, and may be configured to cycle through, over time, one or more frequencies sequentially for a desired period of time (referred to herein as “sweeping” across frequency rates). The controller 102 may be a direct digital synthesis processor, analog voltage-controlled oscillator, phase-locked loop, function generator, or any other signal processor capable of generating a sweeping range of frequencies. In one embodiment, the frequency sweep range and frequency sweep rate are predetermined, whereby the sweeping range function of the controller 102 is operable to produce a plurality of ultrasonic waves 105 throughout a predetermined frequency sweep range at a predetermined frequency sweep rate. In one embodiment, the frequency function of the controller 102 is manually adjustable, thereby allowing the frequency sweep range and the frequency sweep rate to be modified according to the growth cycle of the one or more surface of the plant.

Transducer 104 may comprise various devices capable of converting electronic signals to sound waves and emitting the sound waves toward a plant. In some embodiments, a transducer 104 may comprise one or more of a speaker, a microphone, a horn, or other suitable devices. piezoelectric transducers, electrostatic transducers, magnetostrictive transducers, horn-loaded loudspeakers, dynamic transducers, hydraulic or pneumatic transducers, or any other transducers capable of generating suitable sonic pressure. The transducers 104 may be configured to emit ultrasonic waves 105 at a SPL greater than 80 dB at a distance 110 of at least 30 cm, but below a safe hearing threshold to prevent adverse health effects to a user. In some embodiments, the transducers 104 may emit the ultrasonic waves 105 at a SPL greater than 80 dB, but below 110 dB. In some embodiments, the one or more transducers 104 be configured to produce a sonic pressure SPL exceeding approximately 80 dB at a distance 110 of approximately 30 cm with a varying range of frequencies.

Although a single transducer 104 is depicted in FIG. 1 and is shown as being capable of emitting sound at a plurality of frequencies of waves 105 simultaneously, in some embodiments, the system 100 may comprise a plurality of transducers 104 which may be any or various combinations of devices capable of achieving the functionality ascribed herein to transducer 104 and the system 100. In some embodiments, when a plurality of frequencies of waves 105 are emitted by the transducer 104, such plurality of frequencies can have at least a first frequency, a second frequency, or various combinations thereof, and the first frequency and second frequency may be the same frequency or different frequencies.

Furthermore, the said transducers 104 may possess the capability to transmit signals with both high and low duty cycles, enabling the emission of ultrasonic frequencies exceeding about 22 KHz. The one or more transducers 104 emit ultrasonic frequencies that fall beyond the range of human auditory perception, thus eliminating the potential for noise pollution within the human hearing spectrum. Moreover, the said one or more transducers are capable of transmitting ultrasonic waves at a range of frequencies to optimize resonance with various leaf structures.

Note also that FIG. 1 depicts transducer 104 at a first position relative to the plant, at a distance 110 from the plant 106. Amplitude of one or more ultrasonic waves 105 may vary over distance and depending on characteristics of media through which the wave travels (e.g., air). In this regard, instance 110 may be selected based on a desired amplitude for one or more selected frequencies of ultrasonic waves 105 to be provided to the plant 106. A user may control distance 110 by repositioning the system 100, the plant 106, or changing position of transducer 104 (e.g., by repositioning a mast or other structure to which the transducer 104 is coupled) relative to the plant 106.

Although not explicitly shown in the FIGs., in an embodiment, the system 100 may comprise one or more additional transducers 104 coupled to controller 102 or additional controllers (not specifically shown) for emitting sound toward the plant from additional positions. The one or more additional transducers 104 can be positioned at a first distance 110 from the plant or at one or more other distances.

In some embodiments, transducer 104 may be coupled to receive one or more signals generated by controller 102 emit a plurality of ultrasonic waves 105 at a plurality of frequencies directed at one or more plant surfaces 106, i.e., leaves and stems. In some embodiments, the one or more transducers 104 emit ultrasonic waves 105 that sweep through a range of frequencies at a frequency sweep rate. For example, the one or more transducers 104 may emit ultrasonic waves 105 that sweep from about 20 kHz to 132 kHz. In some embodiments, a sweep range may be limited by capacity of the processing unit 203 and controller 102 and can include frequencies up to 1,000 kHz or more. Transducer 104 may be configured to emit other frequencies in some embodiments. In some embodiments the one or more transducers 104 emit ultrasonic waves at varying frequencies within the frequency sweep range simultaneously.

In some embodiments, the one or more transducers 104 emit ultrasonic waves 105 having frequencies generally in the range of the natural frequencies of one or more surfaces of the plant. In some embodiments, the one or more transducers 104 emit ultrasonic waves 105 having frequencies generally in the range of one or more surfaces of the plant 106. Generally, in the range of one or more harmonic frequencies or the natural frequency is used herein to mean within about 1%, 2%, 3%, 5%, or 10% of the one or more harmonic frequencies or the natural frequency of the one or more surfaces of the plant 106.

As shown in FIG. 1, the one or more transducers 104 receive the electronic signals from the controller 102 and emit a plurality of ultrasonic waves 105 at a plurality of frequencies directed at one or more plant surfaces 106. In a preferred embodiment, the one or more transducers 104 emit a plurality of ultrasonic waves 105 in a sweeping range of frequencies at a rate directed at a plant surface 106, thereby, generating standing waves with multiple varying sizes of plants and leaves over time. In a preferred embodiment, the one or more transducers 104 emit ultrasonic waves 105 at a sound pressure level (SPL) greater than 80 dB at distance 110 of 30 cm.

Advantageously, the system 100 finds application in outdoor, greenhouse, or indoor environments and can be effectively employed in conjunction with grow lights, soil, fertilizers, or hydroponic systems.

As shown in FIG. 1, in an exemplary embodiment, the plurality of transducers 104 are capable of emitting a sweeping range of ultrasonic waves 105 at a sweeping range of frequencies. The one or more transducers 104 may be arranged to emit a sweeping range of ultrasonic waves 105 at varying frequencies, specifically designed to facilitate optimum resonance in varying plant leaf sizes. In some embodiments, a plurality of transducers 104 may emit different frequencies within the sweeping range of ultrasonic waves simultaneously. Each of the one or more transducers 104 may be configured to operate across a distinct or overlapping frequency range. The ultrasonic waves 105 may be emitted in a sweeping fashion, meaning the frequencies shift or change over time. The said sweeping range may cover ultrasonic frequencies between about 22 kHz up to 1,000 kHz.

The duration of the emission of the sweeping range of ultrasonic waves 105 directed at the surfaces of the plant 106 can vary. In some embodiments, ultrasonic waves are emitted for specific intervals (e.g., minutes, hours, or days). In other embodiments, the duration of the emission of the sweeping range of ultrasonic waves 105 directs at the surface of the plant 106 can continue indefinitely. In other embodiments, the system 100 can be manually overridden to stop its operation and may be electrically connected to the operating environment's lighting system to shut off simultaneously with the lights of the operating environment.

The duration of the emission of each frequency in the sweeping range of ultrasonic waves 105 directed at the surfaces of the plant 106 can also vary. In some embodiments, the duration of emission of each certain frequency in the sweeping range of ultrasonic waves 105 directed at the surfaces of the plant 106 is greater than 250 microseconds. In other embodiments, the duration of the duration of emission of each certain frequency in the sweeping range of ultrasonic waves 105 directed at the surfaces of the plant 106 may vary, whereby the duration of the emission of one certain frequency is longer or shorter than the emission of another certain frequency in the sweeping range.

This capability leads to the global optimization of leaf growth through resonance, as opposed to the limited achievement of optimal resonance at a single wavelength. The present disclosure may be programmed to emit frequencies tailored for specific plant species based on empirical data of resonant frequencies associated with each species' growth cycle. By way of example, for a plant with leaves ranging from about 3 inches to about 4 inches, utilizing a frequency tailored specifically for about 3-inch leaves may indeed induce resonance to some degree in the about 3-inch leaves. However, it would not effectively resonate with the about 4-inch leaves. Hence, it proves more advantageous to employ a range of frequencies capable of resonating with leaves of various sizes, rather than adhering to a consistent single frequency. This diversity in leaf sizes mirrors the natural progression of plant growth, where leaves undergo size changes over time, resulting in distinct resonant frequencies at different developmental stages. Consequently, relying on a solitary frequency may yield satisfactory results at certain times but fall short at others, whereas cycling through a spectrum of frequencies enhances the likelihood of consistently achieving resonant outcomes.

As shown in FIG. 1, in an exemplary embodiment, the system 100 comprises a controller 102 whereby a user may pre-set one or more frequency sweep ranges and one or more frequency sweep rates. A controller 102 may be a mechanical, electro-mechanical, or electronic device. A controller 102 may also be a programmable logic controller or a computer or a processor-controlled device, such as, by way of example, personal computers, mini-computers, laptop computers, smartphones, tablets, mobile computers, portable computers, handheld computers, palmtop computers or any combination thereof. The controller 102 may be utilized to allow a user to manually adjust or fine-tune the sweeping range of ultrasonic frequencies and the frequency sweep rate in accordance with the growth cycle of the one or more surfaces of the plant.

FIG. 2 shows an exemplary controller 102 in accordance with some embodiments of the present disclosure. The exemplary controller 102 of FIG. 2 includes a processing unit 203, transducer interface 204, a user interface 206, a sensor interface 207, and communication interface 208, although other components are possible in other embodiments. The controller 102 also includes at least one memory 210 which stores sonic data 220, control logic 222 and sonic instructions 224. A controller 102 may store other information and instructions in other embodiments. Although the controller 102 is shown as having particular components and information, in some embodiments, a controller 102 may include some, all or various combinations of the components of FIG. 2 or yet other components and information in order to achieve the functionality described herein.

The exemplary controller 102 depicted by FIG. 2 includes at least one conventional processing unit 203, which includes processing hardware for executing instructions stored in memory 210. The processing unit 203 may be various types of processor and may include various types of hardware, software, memory, and circuitry as is necessary to perform and control the functions of controller 102. As an example, the processing unit 203 may include a central processing unit (CPU) or a digital signal processor (DSP). Processing unit 203 may include various numbers of processors and may perform the operations of controller 102 based on instructions in one or more memories and memory types, such as memory 210. As used herein, memory may refer to any suitable tangible or non-transitory storage medium. Examples of a tangible (or non-transitory) storage medium may include disks, thumb drives, and memory, etc., but does not include propagated signals. Tangible computer readable storage mediums may include volatile and non-volatile, removable and non-removable media, such as computer readable instructions, data structures, program modules or other data. Examples of such media may include RAM, ROM, EPROM, EEPROM, SRAM, flash memory, disks or optical storage, magnetic storage, or any other non-transitory medium that stores information that is accessed by a processor or computing device

The processing unit 203 is configured to communicate with and drive the other elements within the controller 102 via a local interface 205, which can include at least bus. In addition, the controller 102 can include various communications and output interfaces (e.g., screens, displays, etc.), which are not specifically shown in FIG. 2, but can be included to allow the controller to perform functionality described herein. In some embodiments, the controller 102 is coupled communicatively to one or more transducer interfaces 204, user interfaces 206 or communication interfaces 208, for example, via conductive means or via short-range communication protocol, such as Bluetooth®.

Although in some embodiments the processing unit 203 and memory 210 will be described implemented in a controller 102 and configured in a particular manner, it will be understood that, in some embodiments, processing unit 203, memory 210, one or more transducer interfaces 204, user interface 206 and communication interface 208 may be configured in any suitable manner to perform the functionality of the controller 102 as is described herein. It will also be understood that the functionality of controller 102 may be embodied in a single device or a plurality of devices, each including one or more or various combinations of processing units and memory to collectively perform the functionalities of one or more controllers 102 as described herein.

The controller 102 may communicate with the one or more transducers 104 via transducer interface 204. The interface 204 may comprise various hardware, software or combinations thereof to enable communication of information to and from transducers 104 to the controller 102 via interface 204. In some embodiments, the interface 204 may enable communication via conductive electronic transmission or using various communications protocols, including those protocols those similar to those described with regard to the communications interface 208 below.

User interface 206 can include various combinations of hardware and software configured to implement a human-machine interface between a user and the controller 102, such as by allowing a user to receive outputs from and provide inputs to the controller. In some embodiments the user interface can include one or more or various combinations of a touchscreen, keyboard, mouse, physical input devices (e.g., buttons or switches), or otherwise.

Sensor interface 207 may facilitate communication between controller 102 and one or more external sensors configured to capture desired information (e.g., one or more states of one or more physical devices, objects, systems, environments, etc.) and provide the information to the controller 102 for use or storage in memory 210. One or more components of the system 100, such as the one or more transducers 104 may be associated with one or more devices, such as sensors (not specifically shown) enabling the controller 102 to receive data. Exemplary devices with which the controller 102 may be in communication may include devices such as one or more sensors, cameras, switches, timers, counters, flow meters, thermometers, speed sensors, microphones, seismometers, acoustic sensors, gauges, optical sensors, spectrometers, displacement sensors, chemical sensors, electromagnetic sensors, electrical sensors, moisture sensors, proximity sensors, or other types of input devices. In some embodiments, controller 102 may receive data from one or more of the foregoing devices for use in executing sonic instructions 224. In addition, the controller 102 may be configured to communicate information to and from the one or more devices and may communicate via communications protocols similar to those described with regard to the communications interface 208 below.

Communication interface 208 may include one or more various combinations of hardware and software configured to communicate with other aspects of the system 100. The communication may be via one or more various communication protocols, such as wireless communication protocols like Bluetooth®, RF communication, NFC communication or otherwise. It will be understood that the functionality ascribed to the controller 102 and components of the system 100 is not necessarily dependent upon communication via a particular protocol, and other communication techniques and interfaces are possible in other embodiments. In this regard, the controller 102 may include one or more communication interfaces 208 that allow for communication using various protocols to facilitate its operation. The specific communication methods used can vary depending on the design and requirements of the system 100 in which the controller is employed. Example communications protocols and techniques may include, but are not limited to the Internet, TCIP/IP, ETP/IP, Pub/Sub Messaging (e.g., MQ Telemetry Transport (“MQTT”), Advanced Message Queuing Protocol (“AMQP”)), Request/Response model (e.g., Reference Transactions API, Customer Information Control System (“CICS”) transactions), modular open radio frequency architecture (“MORA”). Payload may be formatted or defined as XML, JSON, machine code, bytecode, binary or hexadecimal code, or otherwise.

Sonic data 220 may include various types of data that controller 102 may require in order to carry out operations of the system 100 and instructions stored in memory 210 on the controller 102 (e.g., as implemented in and carried out by control logic 222), and may include data related to utilization of ultrasonic waves to promote plant growth, as well as data related to the state of the controller 102, system components, or otherwise. In some embodiments, sonic data 220 can include one or more sweeping frequency functions indicative of at least one frequency sweep range and at least one frequency sweep rate, and can indicate various information about plant types, data about ultrasonic frequencies (e.g., harmonic, natural, or other frequencies) determined to promote growth for one or more types of plants, durations for sweep rates, distance of one or more transducers from a plant surface for particular frequencies and amplitudes of sound waves, and essentially any other data suitable for use in executing sonic instructions 224 by processing unit 203.

To further describe and reiterate types that may be included in sonic data 220, where the controller 102 is configured to measure information about the utilization of ultrasonic waves to promote plant growth, the sonic data 220 can include various information about the distance of the one or more transducers relative to the one or more surfaces of the plant, the frequency sweep range, frequency sweep rate, the duration of the sweeping range of frequencies. Additionally, the sonic data 220 may include metrics on the timing and intensity of the ultrasonic wave emissions, any sensed or observed effects on plant growth or cellular activity, and real-time environmental conditions. Other sonic data 220 may include specific parameters of the ultrasonic waves, such as sound pressure levels and response time, as well as any anomalies detected during the utilization of ultrasonic waves to promote plant growth.

Although particular examples of controller functionality may be described with reference to controller 102, in some embodiments, controller 102 (e.g., control logic 222) can be configured to perform essentially any of the functionalities ascribed herein to other components or devices within the system 100. Similarly, in some embodiments, other components or devices within the system 100 may be configured to perform some or all of the functionalities ascribed to the controller 102 (e.g., control logic 222). In the context of this document, the terms “logic,” or “control logic,” may refer to hardware logic, computer readable instructions running on a processor, or various combinations thereof. The logic 222 may be configured to implement desired functionality of the controller 102 or various combinations of such functionality and used to control operation of the system 100.

The control logic 222 may include instructions for controlling various operations of the controller 102, such as internal communications, power management, processing of messages, systems monitoring, device interface and user interface control, operation of sensor interface 207, operation of communication interface 208, and the management of other sets of instructions. In one embodiment, the logic 222 may provide an operating system and applications necessary to perform various processing operations that are performed by the processing unit 203 and ascribed to the controller 102, logic 222, or various combinations thereof.

Sonic instructions 224 can include instructions for identifying frequencies that should be generated and provided by the system to interact with surfaces of and portions of a plant to cause it to vibrate and a resonant frequency and thereby promote plant growth.

In some embodiments, sonic instructions 224 can include instructions for accessing, by the processing unit, sonic data to identify at least one sweeping frequency function indicative of at least one frequency sweep range and at least one frequency sweep rate, wherein the at least one sweeping frequency function is based on a plant type and distance from a plant surface at which the one or more transducers is positioned.

In some embodiments, sonic instructions 224 can include instructions for identifying a first frequency sweep range and a first frequency sweep rate according to the at least one sweeping function. A sweeping function may comprise information regarding relationships between one or more ultrasonic frequencies that should be emitted, rate at which the system should sweep through the one or more frequencies in the range, and other information regarding frequencies across switch the system will sweep as it generates and emits ultrasonic sound waves. A frequency sweep range may comprise a range of frequencies across which the system will generate and provide one or more waves. A frequency sweep rate may comprise durations for which the system will emit each of one or more ultrasonic waves during a frequency sweep. In some embodiments, at least one sweeping frequency function may be based on one or more frequencies at which one or more plant surfaces are vibrated at a plurality of wavelengths, and at least one of the plurality of wavelengths may be selected to match a standing wave resonance frequency (e.g., harmonic, natural, or other frequency) for the one or more plant surfaces.

In some embodiments, sonic instructions 224 can include instructions for identifying a first ultrasonic wave frequency that should be emitted by the one or more transducers based on the first frequency sweep range. Again, the sweet range may be indicative of a range of frequencies that should be emitted by the system. In some embodiments, sonic instructions 224 can include instructions for generating a first signal indicative of the first ultrasonic wave frequency and providing the first signal to the one or more transducer. The controller 102 can execute the sonic instructions to monitor a period of time that has elapsed during which transducer 104 has been emitting an ultrasonic wave at the first frequency of the sweep range. The controller 102 further can execute the sonic instructions to determine when the period of time has reached a duration threshold that indicates that it is time to emit a next frequency in the sweep range. In this regard, the controller 102 can execute the sonic instructions 224 to generate a next signal and provide that signal to the transducer 104 for admission at the next frequency of the sweep range, thereby changing the frequency of the sonic wave emitted by the transducers. In this regard, the instructions 2224 can include instructions for determining that a first time period associated with the first frequency sweep rate has elapsed and identifying a second ultrasonic wave frequency that should be emitted by the one or more transducers based on the first frequency sweep range.

The instructions 224 can generally include instructions for repeating the process for a second frequency and rate of the sweep range. In some embodiments, sonic instructions 224 can include instructions for generating a second signal indicative of the second ultrasonic wave frequency and providing the second signal to the one or more transducers 104. In some embodiments, sonic instructions 224 can include instructions for determining that a second time period associated with the first frequency sweep rate has elapsed. Note that in some embodiments this second time period may be the same as or different from the first time period.

The controller 102 may continue generating and providing signals associated with each frequency of the frequency sweep range until it is time either move on to a subsequent sweep range (e.g., because the first sweep range is complete), to repeat generating and providing signal frequencies associated with the first sweep range, or, alternatively, the controller may determine that processing should stop and may deactivate or disable components of the system 100, such as the transducers and wait for instructions to begin processing again. In some embodiments, sonic instructions 224 can include instructions for identifying a third ultrasonic wave frequency that should be emitted by the one or more transducers based on the first frequency sweep range. In some embodiments, sonic instructions 224 can include instructions for generating, a third signal indicative of the third ultrasonic wave frequency and providing the third signal to the one or more transducers. In some embodiments, sonic instructions 224 can include instructions for determining, that a third time period associated with the first frequency sweep rate has elapsed and that the third ultrasonic wave frequency is a final frequency of the first frequency sweep range. In some embodiments, sonic instructions 224 can include instructions for disabling the one or more transducers. In some embodiments the sonic instructions 224 can include instructions for repeating the first sweep range, moving on to a subsequent sweep range, waiting for instructions to continue, or other action.

In some embodiments, sonic instructions 224 can include instructions for subjecting one or more surfaces of a plant for a duration to ultrasonic waves through a sweeping range of frequencies at a frequency sweep rate such that the surfaces of the plant are vibrated generating standing wave resonance and increasing turgor pressure in the surfaces of said plant. In some embodiments the sweeping range of frequencies may be capable of generating standing wave resonances (again, harmonic, natural, or other frequency) at a plurality of wavelengths while the plant grows.

The sonic instructions 224 further may comprise instructions for setting one or more frequency sweep ranges and one or more frequency sweep rates. Note that the sweeping range of frequencies at a frequency sweep rate may be predetermined, and the controller 102 may allow a user to control or manually adjust a sweeping range of frequencies at a frequency sweep rate. In addition, the sonic instructions 224 may comprise instructions for subjecting one or more surfaces of a plant for a duration to ultrasonic waves at one-half wavelength of the fundamental frequency through a sweeping range of frequencies at a frequency sweep rate.

In some embodiments, the sonic instructions 224 may comprise instructions for subjecting one or more surfaces of a plant to ultrasonic waves through sweeping range of frequencies comprising frequencies between 22 kHz and 132 kHz. Other frequency ranges are possible (e.g., up to 1,000 kHz or more). In some embodiments, the ultrasonic waves applied to one or more surfaces of a plant may have a sound pressure level of at least 80 dB at 30 cm. In some embodiments, the frequency sweep and frequency sweep rate may be cycled for a predetermined duration of a first cycle, and the first cycle duration of the frequency sweep is between about 1 second and 24 hours. Other cycle durations are possible and can vary to less than one second (e.g., 1/1000000 seconds) and greater than 24 hours (e.g., 1 week or more). In some embodiments, the sonic instructions 224 may comprise instructions for varying the sweep rate of the frequency sweep during the first cycle. In some embodiments, sonic instructions 224 may comprise instructions for repeating the frequency sweep and frequency sweep rate for at least a second cycle.

### C. Methods of Ultrasonic Utilization to Promote Plant Growth

As disclosed herein, the present disclosure encompasses a method for enhancing plant growth by exposing the plant's surfaces to ultrasonic waves. The disclosed method comprises subjecting the surface of the plant to ultrasonic waves for a predetermined duration. The ultrasonic waves are applied over a predetermined sweeping range of frequencies at a predetermined frequency sweep rate. The sweeping range of frequencies ensures that various resonant frequencies are covered, each capable of producing standing wave resonance across different parts of the said plant's surface. This standing wave resonance induces vibrations in the plant's surface, leading to an increase in turgor pressure in the plant's cells. The increase in turgor pressure enhances the plant's ability to absorb nutrients and water, thus promoting faster and more robust plant growth. The surfaces of the said plant are vibrated, generating standing wave resonance, and increasing the turgor pressure in the surfaces of the said plant. The said sweeping range of frequencies is capable of generating standing wave resonances at a plurality of wavelengths during the growth of the said plant. The method is applicable in real-world agricultural and horticultural settings, utilizing ultrasonic waves to induce specific vibrational frequencies within plant surfaces. This practical application leads to measurable improvements in plant cellular activity, water absorption (via increased turgor pressure), and growth rates—achieving concrete results in both indoor and outdoor farming environments.

The disclosed method utilizes a signal processor capable of generating ultrasonic waves at a plurality of frequencies. The signal processor is electrically coupled to one or more transducers configured to emit ultrasonic waves at a plurality of frequencies directed at one or more plant surfaces. In FIG. 1, the one or more transducers 104 are positioned above the body of the plant at a distance and directed downwards towards the plant surface. In other aspects, other arrangements of the one or more transducers 104 may be used. In some embodiments, a single transducer 104 may be used.

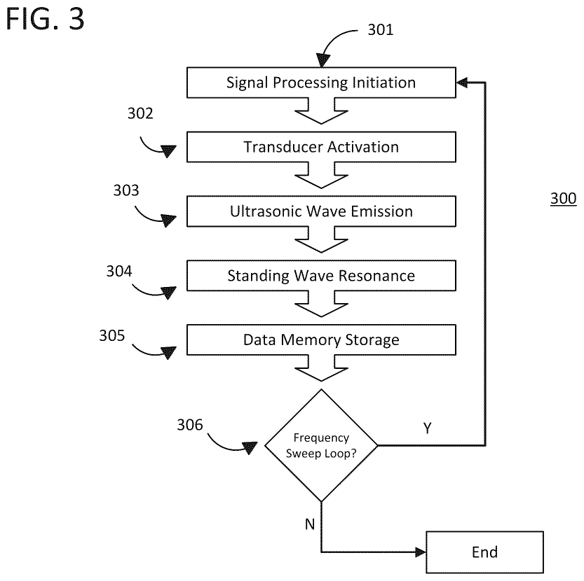

FIG. 3 depicts an exemplary method 300 for utilizing ultrasonic waves to promote plant growth in accordance with some embodiments of the present disclosure. As shown in FIG. 3, at step 301, a controller generates ultrasonic waves across a frequency sweep range at frequency sweep rate for a duration. In some embodiments, a controller may be utilized to manage the signal processing initiation at step 301, adjusting the input parameters to optimize frequency sweep range and frequency sweep rate selection. The controller transmits the signal process initiation 301 to the one or more transducers 104.

At step 302, one or more transducers 302 receive signals from the controller 301. At step 303, the one or more transducers emit ultrasonic waves that sweep through a range of frequencies at a frequency sweep rate. In one embodiment, the one or more transducers may emit ultrasonic waves during a sweep across a range of frequencies between 20 kHz to 40 kHz. In some embodiments, the range of frequencies may be between 35 kHz to 45 kHz. Other frequency sweep ranges are possible in other embodiments. In some embodiments, the one or more transducers 104 may emit ultrasonic waves during a sweep across a range of frequencies between 20 kHz to 1,000 kHz. In some embodiments, the one or more transducers 104 emit ultrasonic waves that sweep in the range of the natural frequencies of one or more surfaces of the plant.

In a preferred embodiment, the method 300 utilizes one or more transducers at step 302 emitting ultrasonic waves at step 303 that sweep in the range of one or more harmonic frequencies or one or more surfaces of the plant. The duration of the emission of the sweeping range of ultrasonic waves directed at the surfaces of the plant can vary. In some embodiments, ultrasonic waves at step 303 are emitted for specific intervals (e.g., minutes, hours, or days).

At step 304, as the plant surface is exposed to the sweeping range of ultrasonic waves, vibrations are induced, generating standing wave resonance or harmonics thereof. In a preferred embodiment, the disclosed method 300 involves subjecting the plant's surfaces to ultrasonic waves at a duration corresponding to frequencies equal to half-wavelengths the fundamental frequency across a broad spectrum of frequencies, all at a controlled frequency sweep rate. In some embodiments, at least one of the plurality of ultrasonic sound waves comprises a wavelength equal to one half a wavelength of a fundamental frequency of the one or more surfaces of the plant. During the application of this sweeping range of ultrasonic frequencies to the plant's surfaces, the induced vibrations generate standing wave resonance and an increase turgor pressure within the plant's surfaces. This sweeping range of frequencies facilitates standing wave resonances at multiple wavelengths, thereby promoting enhanced plant growth.

At step 305, the method may utilize a controller 102 to collect and store data on the distance between the transducers and the one or more surfaces of the plant, the frequency range of the ultrasonic waves, the sound pressure levels, and the duration of the emissions. The controller maintains a historical record of the ultrasonic emission parameters, which can be used for evaluating performance trends, troubleshooting.

At step 306, the duration of the emission of the sweeping range of ultrasonic waves applied the surface of the plant may cycle through the frequency sweep range at the frequency sweep rate one or more times. The defined duration of signal processing initiation at step 301 may be defined to cycle through the frequency sweep range and frequency sweep rate one or more times. In another embodiment, the defined duration of the signal processing initiation at step 301 may be indefinite. In another embodiment, the defined duration of the signal processing initiation at step 301 may be defined to cycle through the frequency sweep range only once. If the defined duration of the signal processing initiation at step 301 is one frequency sweep cycle, the process terminates. If the defined duration of the signal processing initiation 301 is more than one frequency sweep cycle, the process reinitiates until the defined duration of the signal processing initiation at step 301 is reached, at which point the process may end.

The duration of the emission of the sweeping range of ultrasonic waves directed at the surfaces of the plant can vary. In some embodiments, ultrasonic waves are emitted for specific intervals (e.g., minutes, hours, or days). In other embodiments, the duration of the emission of the sweeping range of ultrasonic waves directs at the surface of the plant can continue indefinitely. In another embodiment, the method 300 can be manually overridden to stop its operation and may involve electrically connecting to the operating environment's lighting system to shut off simultaneously with the lights of the operating environment. In some embodiments, other components of the system 100 may be used to control operation of the system 100 based on sensed environmental conditions such as lighting, for example when the system 100 comprises a switch, such as a photoresistor, sensor or other device, configured to cause the controller 102 to prevent transmission of ultrasonic waves 105 when it is determined that light is not present in the system 100's environment.

The duration of the emission of each frequency in the sweeping range of ultrasonic waves directed at the surfaces of the plant can also vary. In some embodiments, the duration of emission of each certain frequency in the sweeping range of ultrasonic waves directed at the surfaces of the plant is greater than 250 microseconds. In other embodiments, the duration of the duration of emission of each certain frequency in the sweeping range of ultrasonic waves directed at the surfaces of the plant may vary, whereby the duration of the emission of one certain frequency is longer or shorter than the emission of another certain frequency in the sweeping range.

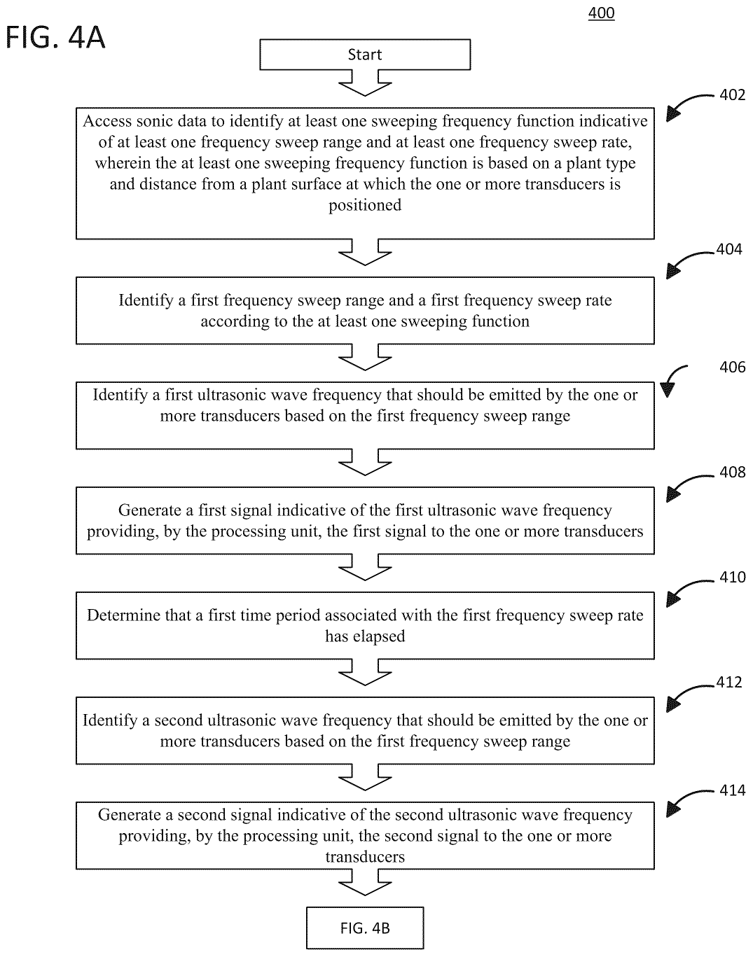

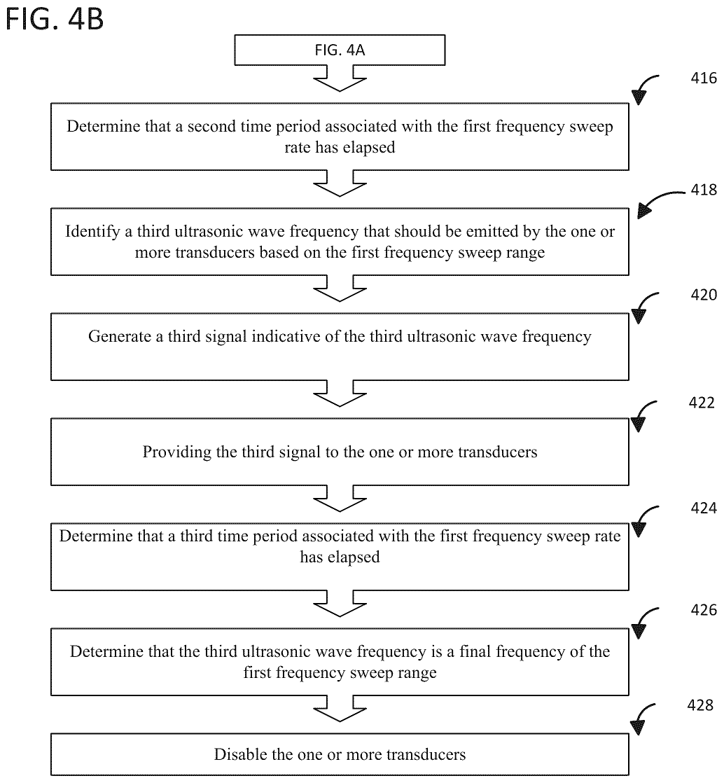

FIGS. 4A and 4B depict an additional exemplary method 400 for utilizing ultrasonic waves to promote plant growth in accordance with some embodiments of the present disclosure. The method 400 may promote plant growth using ultrasonic sound waves by one or more transducers and a controller comprising memory storing sonic instructions and sonic data and a processing unit configured to execute the sonic instructions. At step 402 the controller may access, by the processing unit, sonic data to identify at least one sweeping frequency function indicative of at least one frequency sweep range and at least one frequency sweep rate. The at least one sweeping frequency function may be based on a plant type and distance from a plant surface at which the one or more transducers is positioned.

Thereafter, the method may proceed to step 404, where the controller may identify a first frequency sweep range and a first frequency sweep rate according to the at least one sweeping function. Thereafter, the method may proceed to step 406, where the controller may identify a first ultrasonic wave frequency that should be emitted by the one or more transducers based on the first frequency sweep range. At step 408, the controller may generate a first signal indicative of the first ultrasonic wave frequency providing the first signal to the one or more transducers. Thereafter, the method may continue to step 410, where the controller may determine that a first time period associated with the first frequency sweep rate has elapsed.

At step 412, the controller may identify, by the processing unit, a second ultrasonic wave frequency that should be emitted by the one or more transducers based on the first frequency sweep range. At step 414, the controller may generate a second signal indicative of the second ultrasonic wave frequency providing the second signal to the one or more transducers. At step 416 the controller may determine that a second time period associated with the first frequency sweep rate has elapsed, and thereafter, the method may continue to step 418.

At step 418, the controller may identify a third ultrasonic wave frequency that should be emitted by the one or more transducers based on the first frequency sweep range. At step 420, the controller may generate a third signal indicative of the third ultrasonic wave frequency. At step 422, the controller may provide the third signal to the one or more transducers. At step 424 the controller may determine that a third time period associated with the first frequency sweep rate has elapsed. At step 426, the controller may determine that the third ultrasonic wave frequency is a final frequency of the first frequency sweep range. The controller may to determine whether any additional sweep ranges should be identified. If additional sweep ranges should be identified, the controller no additional frequency sweep ranges should be applied. Thereafter processing may proceed to step 428.

At step 428 the controller may disable, by the processing unit, the one or more transducers.

The disclosed methods are adaptable to various plant species and types. The ultrasonic wave frequencies can be adjusted to optimize resonance frequencies according to plant size and leaf structure and may be fine-tuned for specific growth stages.

### D. Testing

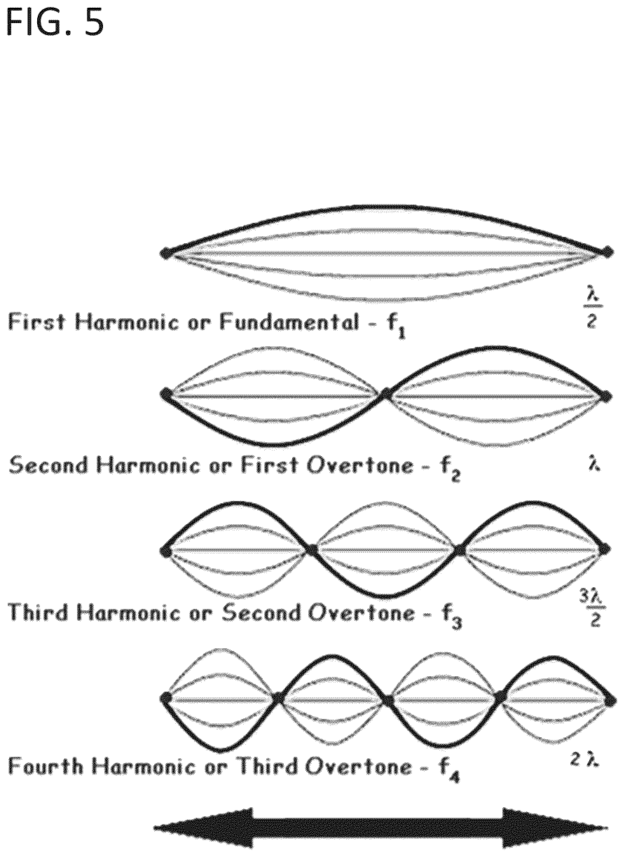

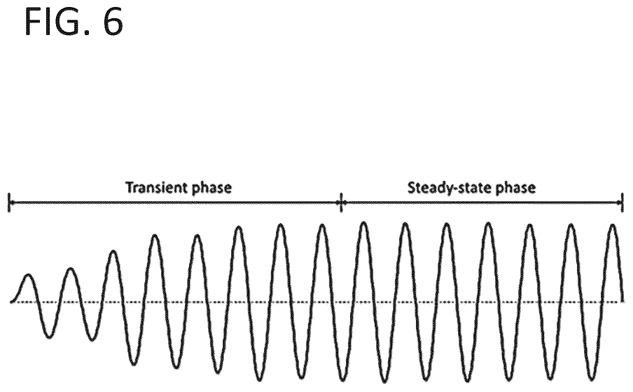

FIG. 5 is an illustration of an integer multiple of harmonics of a fundamental frequency, and FIG. 6 is an illustration of exemplary standing wave resonance in accordance with some embodiments of the present disclosure. System 100 may be configured to operate substantially in accordance with the observations described in FIGS. 5-8. In a controlled laboratory setting, the present disclosure underwent testing to evaluate the effectiveness of the ultrasonic plant growth system and method. The test environment included two setups: one incorporating the ultrasonic plant growth system and method and another serving as a control without ultrasonic exposure. This setup facilitated a direct comparison between the experimental setup incorporating the ultrasonic plant growth system and method and the control. Both setups featured identical components, including grow lights, Miracle Gro® potting mix, and Blue Lake Bush Green Beans seedlings, which were uniform in size just two days after germination.

Observations revealed that the control exhibited low turgor pressure, as evidenced by wilted or droopy leaves. In contrast, the experimental setup displayed high turgor pressure, with leaves appearing stiffened or distended.

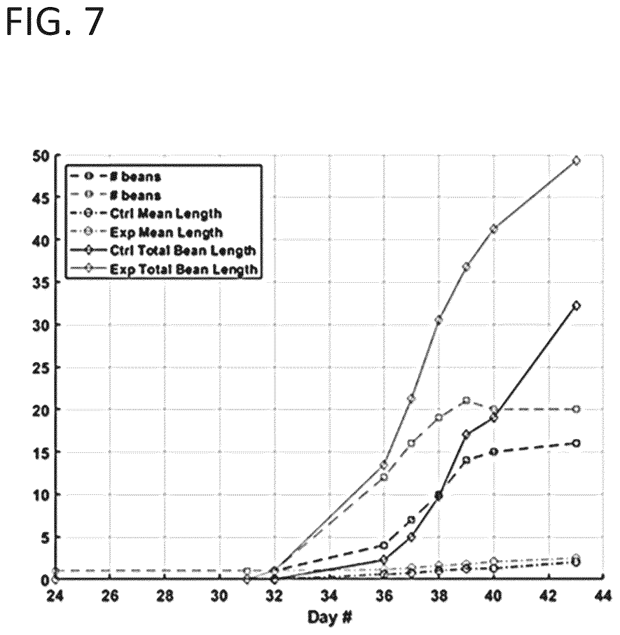

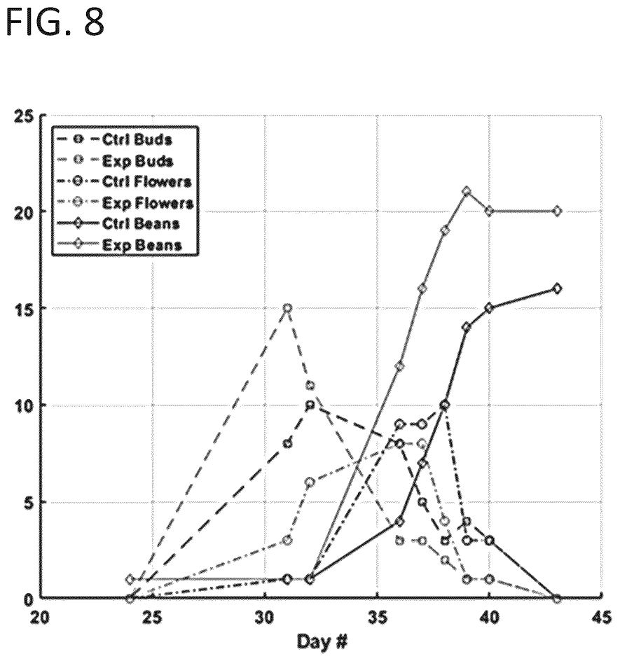

As shown in FIGS. 7 and 8, after 20 days of germination, noteworthy differences were noted. The experimental group demonstrated a growth advantage of approximately 2-3 days over the control group. The leaf widths and lengths of the experimental group exceed those of the control group, until reaching approximately five inches in length. Additionally, the Green Beans in the experimental setup commenced growth roughly 2-3 days ahead of their counterparts in the control group, and ultimately yielded 25% more green beans compared to the control group. During the growth phase, before the need for external support such as a trellis, the experimental setup's leaves in the exhibited remarkable turgor pressure, while the leaves in the control group drooped noticeably.

The results indicate that the ultrasonic plant growth system and method effectively enhances plant growth and turgor pressure, leading to earlier growth, larger leaf dimensions, and higher yields compared to conventional growth methods without ultrasonic exposure. The data supports the efficacy of the ultrasonic plant growth system and method in improving plant health and productivity in a controlled environment.

Although embodiments of the present disclosure have been described in detail, it will be understood by those skilled in the art that various modifications can be made therein without departing from the spirit and scope of the invention as set forth in the appended claims.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

The previous detailed description has been provided for the purposes of illustration and description. Thus, although there have been described particular embodiments of a new and useful invention, it is not intended that such references be construed as limitations upon the scope of this disclosure except as set forth in the following claims.

What is claimed is:

1. An ultrasonic plant growth system comprising:
a power source;
one or more transducers operable to emit a plurality of ultrasonic sound waves to impact on one or more surfaces of a plant;
a controller coupled to the power source and the one or more transducers and comprising memory and a processing unit, the memory storing sonic instructions and sonic data, and the processing unit configured to execute the sonic instructions to:
access sonic data to identify at least one sweeping frequency function indicative of at least one frequency sweep range and at least one frequency sweep rate, wherein the at least one sweeping frequency function is based on a plant type and distance from a plant surface at which the one or more transducers is positioned;
identify a first frequency sweep range and a first frequency sweep rate according to the at least one sweeping function;
identify a first ultrasonic wave frequency that should be emitted by the one or more transducers based on the first frequency sweep range;
generate a first signal indicative of the first ultrasonic wave frequency
provide the first signal to the one or more transducers;
determine that a first time period associated with the first frequency sweep rate has elapsed;
identify a second ultrasonic wave frequency that should be emitted by the one or more transducers based on the first frequency sweep range;
generate a second signal indicative of the second ultrasonic wave frequency
provide the second signal to the one or more transducers;
determine that a second time period associated with the first frequency sweep rate has elapsed;
identify a third ultrasonic wave frequency that should be emitted by the one or more transducers based on the first frequency sweep range;
generate a third signal indicative of the third ultrasonic wave frequency
provide the third signal to the one or more transducers;
determine that a third time period associated with the first frequency sweep rate has elapsed; and
determine that the third ultrasonic wave frequency is a final frequency of the first frequency sweep range.

2. The system of claim 1, wherein the at least one sweeping frequency function is based on one or more frequencies at which one or more plant surfaces are vibrated at a plurality of wavelengths, wherein at least one of the plurality of wavelengths is selected to match a standing wave resonance frequency or harmonic standing wave frequency for the one or more plant surfaces.

3. The system of claim 1 wherein the at least one sweeping frequency function is indicative of a predetermined frequency sweep range and a predetermined frequency sweep rate.

4. The system of claim 3 wherein predetermined frequency sweep rate comprises a predetermined duration for each frequency within the frequency sweep range.

5. The system of claim 1 wherein a user may provide input to control the at least one sweeping frequency function.

6. The system of claim 1, wherein at least one of the plurality of ultrasonic sound waves comprises a wavelength equal to one half a wavelength of a fundamental frequency of the one or more surfaces of the plant.

7. The system of claim 1, wherein the frequency sweep range comprises frequencies between about 22 kHz and 132 kHz.

8. The system of claim 1 wherein the sonic instructions further comprise instructions for generating an ultrasonic wave which, when emitted by the transducer, comprises a sound pressure level of at least 80 dB when the distance from the plant surface is at least 30 cm.

9. A method for promoting plant growth, consisting of:
subjecting one or more surfaces of a plant for a duration to ultrasonic sound waves through at least one frequency sweep range and at least one frequency sweep rate; whereby the surfaces of the said plant are vibrated generating standing wave resonance and increasing turgor pressure in the surfaces of said plant; wherein the said sweeping range of frequencies is capable of generating standing wave resonances or harmonic standing wave frequencies at a plurality of wavelengths while the said plants grows.

10. The method of claim 9 further comprising using a controller to determine the at least one frequency sweep range and the at least one frequency sweep rate.

11. The method of claim 9 wherein the at least one frequency sweep range and the at least one frequency sweep rate are predetermined.

12. The method of claim 9 wherein a user may provide input to control the at least one frequency sweep range and the at least one frequency sweep rate.

13. The method of claim 9 consisting of subjecting the one or more surfaces of the plant for a duration to ultrasonic sound waves comprising a wavelength equal to one-half a wavelength of a fundamental frequency of the one or more surfaces of the plant.

14. The method of claim 9 consisting of subjecting one or more surfaces of a plant to ultrasonic sound waves through at least one frequency sweep range comprising frequencies between 22 kHz and 132 kHz.

15. The method of claim 9 wherein the ultrasonic sound waves applied to one or more surfaces of the plant comprises a sound pressure level of at least 80 dB when the distance from the plant surface is at least 30 cm.

16. The method of claim 9 wherein the at least one frequency sweep and the at least one frequency sweep rate is cycled for a predetermined duration of a first cycle.

17. The method of claim 16 wherein the first cycle duration of the at least one frequency sweep is between about 1 second and 24 hours.

18. The method of claim 16 wherein the at least one frequency sweep rate is varied during the first cycle.

19. The method of claim 16 wherein the at least one frequency sweep range and the at least one frequency sweep rate are repeated for at least a second cycle.

20. A method to promote plant growth using ultrasonic sound waves by a system comprising one or more transducers and a controller comprising memory storing sonic instructions and sonic data and a processing unit configured to execute the sonic instructions, the method comprising:
accessing, by the processing unit, sonic data to identify at least one sweeping frequency function indicative of at least one frequency sweep range and at least one frequency sweep rate, wherein the at least one sweeping frequency function is based on a plant type and distance from a plant surface at which the one or more transducers is positioned;
identifying, by the processing unit, a first frequency sweep range and a first frequency sweep rate according to the at least one sweeping function;
identifying, by the processing unit, a first ultrasonic wave frequency that should be emitted by the one or more transducers based on the first frequency sweep range;
generating, by the processing unit, a first signal indicative of the first ultrasonic wave frequency
providing, by the processing unit, the first signal to the one or more transducers;
determining, by the processing unit, that a first time period associated with the first frequency sweep rate has elapsed;
identifying, by the processing unit, a second ultrasonic wave frequency that should be emitted by the one or more transducers based on the first frequency sweep range;
generating, by the processing unit, a second signal indicative of the second ultrasonic wave frequency
providing, by the processing unit, the second signal to the one or more transducers;
determining, by the processing unit, that a second time period associated with the first frequency sweep rate has elapsed;
identifying, by the processing unit, a third ultrasonic wave frequency that should be emitted by the one or more transducers based on the first frequency sweep range;
generating, by the processing unit, a third signal indicative of the third ultrasonic wave frequency
providing, by the processing unit, the third signal to the one or more transducers;
determining, by the processing unit, that a third time period associated with the first frequency sweep rate has elapsed; and
determining, by the processing unit, that the third ultrasonic wave frequency is a final frequency of the first frequency sweep range.
